(19) United States
(12) Patent Application Publication
(10) Pub. No.: US 2010/0325652 A1
(43) Pub. Date: Dec. 23, 2010

(54) METHOD OF PERFORMING DATA COMMUNICATION WITH TERMINAL AND RECEIVER USING THE SAME

(76) Inventors: Shim Hong Lee, Seoul (KR); Jae Hyun Park, Seoul (KR); Kyong Soo Hwang, Seoul (KR); Hee Ki Kim, Seoul (KR); Hong Ki Kim, Seoul (KR); Myoung Hwa Ko, Seoul (KR)

Correspondence Address: KED & ASSOCIATES, LLP, P.O. Box 221200, Chantilly, VA, 20153-1200, US

(21) Appl. No.: 12/525,972

(22) PCT Filed: Jun. 18, 2007
(86) PCT No.: PCT/KR07/02937

§ 371 Date: Sep. 3, 2010

(30) Foreign Application Priority Data
Feb. 6, 2007 (KR) 10-2007-0012078

(51) Int. Cl. H04N 7/16; H04N 7/173

(52) U.S. Cl. 725/28; 725/100

(57) ABSTRACT

A method of performing data communication with a terminal and a receiver using the same enables viewing of a broadcast program and a video program of an external device outside the home. The method includes steps of receiving a control signal from a terminal via a network, the control signal including a request signal identifying a specific video program; processing, in response to the received control signal, the specific video program according to characteristic information of the terminal; and transmitting the processed video program to the terminal via the network. The characteristic information for the terminal may or may not be included in the control signal, since a system controller of the receiver may access a user information storage unit to retrieve terminal characteristic information indicating the appropriate format conversion for the terminal.

### TECHNICAL FIELD

The present invention relates to a method of performing data communication with a terminal and a receiver using the same.

### BACKGROUND ART

Real-time video content can be provided to viewers via the Internet as well as conventional radio wave media, e.g., terrestrial or satellite broadcasting and cable hookups, to thereby provide Internet protocol television (IPTV) as well as traditional broadcast programming and news, including video-on-demand content, games, and the like. Internet protocol television is a broadcast service providing information services, moving picture content, and other broadcasts to a television receiver via a high-speed Internet connection, for example, by connecting a set-top box to a network, i.e., the Internet, in a manner similar to a conventional cable hookup. Thus, IPTV video content may be viewed, by a subscriber, using a television receiver installed anywhere, particularly including the home.

Yet IPTV viewing is disadvantageous due to its limited venue for viewing subscribed (i.e., paid for) programming. That is, typically, the subscriber service is provided to an individual residence, with no provision for viewing outside the home. Comparably, an externally input video program, say, via an external recorder/reproducer or similar peripheral device, also represents video content that has been paid for cannot be readily viewed outside the home.

Alternatives to the conventional limitations in broadcast programming content include digital multimedia broadcasting (DMB). The viewing of DMB content, however, necessitates a separate DMB reception module, with terrestrial DMB viewing being restricted according to location (reception module installation) and satellite DMB viewing requiring separate billing and payment protocols.

Meanwhile, for multimedia broadcasting outdoors, a mobile terminal is capable of receiving broadcasts using a variety of media, such as DMB, digital video broadcasting-handheld (DVB-H), and Mediaflo. This mobile broadcast receiver can be provided by loading a broadcast receiving function into a personal portable terminal, e.g., a cellular telephone, a PDA, a laptop, or an in-vehicle terminal, to serve as an IP broadcast receiver. The available content for such a mobile broadcast receiver, however, is still limited to a predetermined number of channels for carrying content and providing services and is unable to access any home-viewable video content, that is, video content that may be viewable in the home of the owner of the mobile broadcast receiver, such as the content of another (simultaneous) subscriber service.

### DISCLOSURE OF INVENTION

### Technical Solution

Accordingly, the present invention is directed to a method of performing data communication with a terminal and a receiver using the same that substantially obviates one or more problems due to limitations and disadvantages of the related art.

An object of the present invention is to provide a method of performing data communication with a terminal and a receiver using the same, by which a broadcast program and a video program of an external device can be viewed outside the home.

Another object of the present invention is to provide a method of performing data communication with a terminal and a receiver using the same, by which home-viewable video content can be viewed outside the home without necessitating separate billing and payment protocols, e.g., additional subscriber fees.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages in accordance with the purpose of the invention, as embodied and broadly described herein, there is provided a method of performing data communication with a terminal at a receiver. The method comprises receiving a control signal from a terminal via a network, the control signal including a request signal identifying a specific video program; processing, in response to the received control signal, the specific video program according to characteristic information of the terminal; and transmitting the processed video program to the terminal via the network.

According to another aspect of the present invention, there is provided a method of performing a data communication with a terminal at a receiver having an internal video recorder/reproducer and at least one input port connected to an external video source. The method comprises receiving a control signal from the terminal via a network, the control signal including a request signal identifying a specific video program; selecting a video program corresponding to the specific video program identified by the control signal; processing, in response to the received control signal, the selected video program according to characteristic information of the terminal; and transmitting the processed video program to the terminal via the network.

According to another aspect of the present invention, there is provided a method of performing a data communication with a terminal at a receiver having an internal video recorder/reproducer and at least one input port connected to an external video source. The method comprises performing, in response to a user request, an authorization process to access a server of a network from the terminal; transmitting a control signal to the receiver via the network upon a successful completion of the authorization process, the control signal including a request signal identifying a specific video program; recognizing one of a plurality of video programs as the specific video program, said recognizing being performed according to the received control signal; selecting a video program corresponding to the recognized video program; processing the selected video program according to characteristic information of the terminal; transmitting the processed video program from the receiver to the terminal via the network; and receiving the transmitted video program at the terminal.

According to another aspect of the present invention, there is provided a receiver comprising a signal input unit for receiving at least one video program; a network interface for performing data communication with respect to a terminal; a controller for controlling an operation of the receiver according to a remote control signal received from the terminal via the network interface, the remote control signal including a request signal identifying a specific video program, and for generating a local control signal for processing the specific video program; and a network signal processor for formatting the specific video program according to characteristic information of the terminal and for transmitting the formatted video program to the terminal via the network interface.

According to another aspect of the present invention, there is provided a receiver comprising a signal input unit for receiving at least one video program; a video storage device for storing the at least one video program according to a user selection; a network interface for performing data communication with respect to a terminal; a controller for controlling an operation of the receiver according to a remote control signal received from the terminal via the network interface, the remote control signal including a request signal identifying a specific video program, and for generating a local control signal for processing the specific video program; a selector for selecting, according to the local control signal, a video program corresponding to the specific video program; and a network signal processor for formatting, in response to the local control signal, the selected video program according to characteristic information of the terminal and for transmitting the formatted video program to the terminal via the network interface.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram a basic system for explaining the concept the present invention;

FIG. 2 is a block diagram of a television receiver for performing data communication with a terminal according to the present invention;

FIG. 3 is a block diagram of a terminal for performing data communication with the receiver of FIG. 2;

FIG. 4 is a diagram illustrating a basic cycle of data communication performed between a terminal and receiver according to the present invention;

FIG. 5 is a flowchart of a method for performing data communication between a terminal and a receiver;

FIG. 6 is a flowchart of a process for performing data communication by confirming the validity of user information according to the present invention;

FIG. 7 is a flowchart of a process for performing data communication by determining the availability of a video program via an external source according to the present invention;

FIG. 8 is a flowchart of a process for performing data communication based on a power status of the receiver according to the present invention; and

FIG. 9 is a flowchart of a process for performing data communication with a receiver in a terminal according to the present invention.

### MODE FOR THE INVENTION

Reference will now be made in detail to exemplary embodiments of the present invention, examples of which are illustrated in the accompanying drawings. Wherever possible, like reference designations will be used throughout the drawings to refer to the same or similar parts.

According to the present invention, a receiver performs data communication with a terminal via an Internet server. The present invention enables remote viewing of a received broadcast program and a video program recording in or provided by an internal or external video storage device. Throughout the following specification, the term “video program” includes a received broadcast program as well as other forms of viewable content that may be carried by data communication between a receiver and a remote terminal device.

The receiver may be a television receiver installed, say, in the home, and the terminal is preferably a mobile terminal capable of transmitting information specifying its characteristics. The mobile terminal characteristics include device information, resolution information (profile, level, etc.), and the like. For this, the receiver includes a network interface to access the Internet server and a network signal processor for processing a video program, which is to be transmitted to the terminal via a network, i.e., the Internet. The processed video program is imparted with characteristics of the terminal's screen, namely, formatting, to enable a video program received at the television receiver (i.e., viewable at home) to be viewed remotely by an authorized user operating the mobile terminal. The receiver may be provided internally with a storage unit for storing user information, including internet access information such as a medium access control (MAC) address, information indicating a terminal's resolution, screen size, etc., and format conversion data. For performing the data communication, the Internet server performs user confirmation and accessing (authorization) processes between the receiver and the terminal and employs a database to store, according to a plurality of user addresses, a set of user registration information (user ID and password) for the user confirmation and accessing processes.

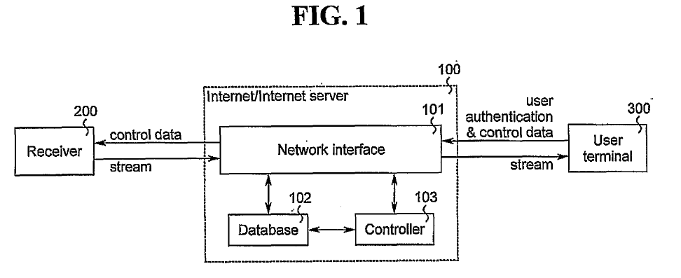

Referring to FIG. 1, a basic system for explaining the concept of the present invention includes a network 100, a receiver 200, and a user terminal 300, whereby the receiver performs data communication with the user terminal via the network, i.e., the Internet including an Internet server. The user terminal 300 is typically a mobile terminal, such as a PCS or cellular telephone, a personal digital assistant (PDA), or a notebook computer, that may be connected by wireless or landline means to the Internet server 100. The Internet server 100 includes a network interface 101 respectively connectible to the receiver 200 and the user terminal 300; a database 102 for storing terminal identifying information; and a controller 103 for determining, in response to an access request made by the terminal, whether terminal identifying information received from the user terminal 300 corresponds to stored terminal identifying information and for connecting the user terminal and the receiver 200 only if it is determined that a terminal identifying information match condition exists.

By thus establishing a connection via the Internet server 100, the receiver 200 receives from the user terminal 300 a control signal including a request signal identifying a specific video program. The control signal may separately include a signal indicating that a user of the user terminal 300 is making a request for a transmission of a video specific program, that is, a transmission (stream) of the identified specific video program to the user terminal from the receiver 200. The control signal may further include a command signal for externally controlling an operation of the receiver 200 using the user terminal 300. Such a command signal may include one or more of a channel up/down signal of the receiver 200, a volume up/down signal of the receiver, an input port selection of the receiver, and a play/stop signal of an external recorder/reproducer or storage device (not shown). The receiver 200 performs a corresponding operation according to the control signal, which is received from the user terminal 300 via the Internet server 100, processes the requested video program to be transmittable according to a terminal type, i.e., a predetermined resolution and screen size, and streams the processed video program to the terminal via the Internet server.

It should be appreciated that, in accordance with available internal and external video sources, video content provided by the receiver 200 of the present invention may include real-time cable and terrestrial television broadcast signals and video programs input from an external recorder/reproducer or stored in (or by) the receiver. The receiver 200 selects a video program identified by the received control signal and processes the video program according to the characteristic of the user terminal 300. Such video program processing converts the identified video program to a format corresponding to the received information indicating the characteristics of the user terminal 300, namely, a video format required for mobile viewing. Prior to its transmission to the user terminal 300, the formatted video program can be scrambled in the receiver 200 to restrict viewing to a specific terminal user.

The Internet server 100 is typically a data communication network providing Internet access, and in an inclusive respect, may include one or more wireless networks such as LAN, WAN, Intranet, systems for evolution data only (EV-DO) mobile communications and wireless broadband Internet (WiBro) connections, and similar networks such as those for mobile and satellite communications, wireless networks of IMT-2000, a public switched telephone network (PSTN), and an exclusive network. Accordingly, network interfaces of the receiver 200 and user terminal 300 are capable of accessing the Internet server 100 via one or more of these networks.

The receiver 200 of the present invention may include a satellite broadcast set-top box, an analog television receiver, or a digital television receiver provided with a digital recorder such as a personal video recorder (PVR) or a digital video recorder (DVR). The receiver 200 is a device capable of providing a video program to the terminal 300 via the Internet server 100 and is controllable by the terminal.

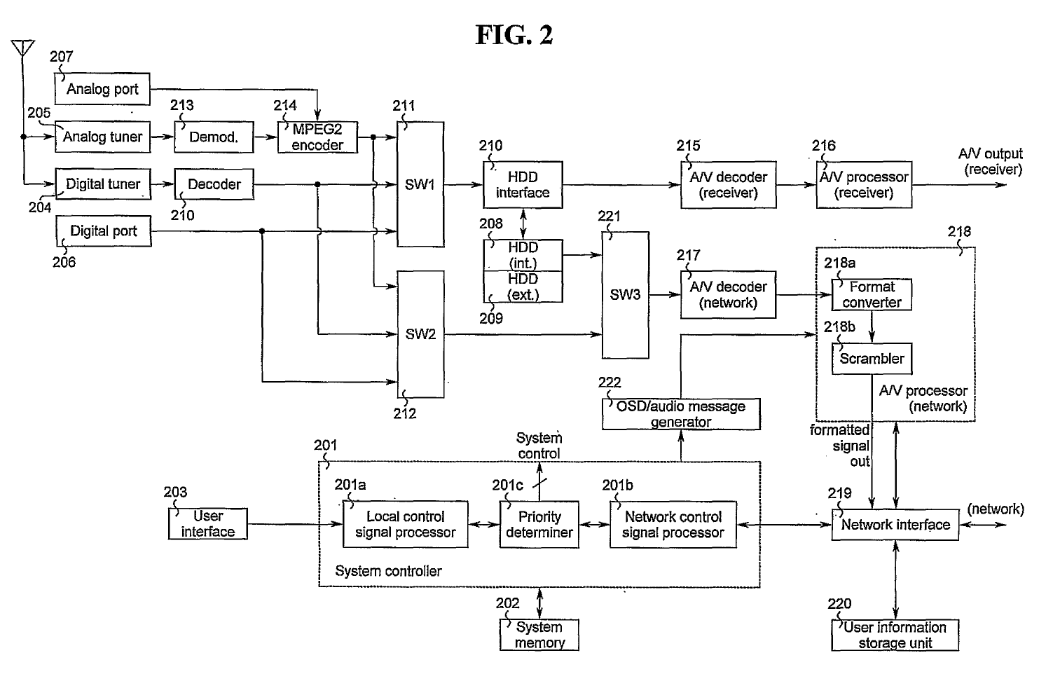

FIG. 2 illustrates a receiver for performing data communication with a terminal according to the present invention. The receiver 200 of the present invention is controlled by a system controller 201 for controlling each element of the receiver system based on a system program and other information stored in a system memory 202 and in accordance with user selections provided via a user interface 203.

The receiver 200 includes a signal input unit as a plurality of video input ports (video input sources) for receiving video content and programming, i.e., at least one video program, through a selected input port. The video input ports may include digital and analog tuners 204 and 205 and digital and analog ports 206 and 207. The digital port 206 may receive digital broadcast signals (e.g., a decoded video feed) or a signal from an external digital player such as a DVD player, and the analog port 207 may receive analog broadcast signals (e.g., a cable input) or a signal from an external analog player such as a videocassette recorder. Besides storage media such as DVDs and video-cassettes, the video input source (video input port) of the receiver 200 may also be one or more video storage devices, which may be provided internal to or external to the receiver, such as an internal hard disc drive (HDD) 208 or an external HDD 209 operated using an HDD interface 210 for controlling the output of the video storage devices. In other words, an internal recorder/reproducer may be a PVR or DVR. Accordingly, the at least one video program may include a real-time digital or analog television broadcast program input via a cable input or corresponding tuner or a video program from an internal or external player or video storage device.

The receiver 200 further includes a decoder 210 for receiving a transport stream from the digital tuner 204 and applying a decoded signal to first and second switches (SW1 and SW2) 211 and 212 and a demodulator 213 and an MPEG2 encoder 214 for receiving an analog signal from the analog tuner 205 and applying a demodulated and encoded signal to each switch as well. Meanwhile, in addition to tuned video signal inputs being applied to each of the first and second switches 211 and 212, an output of the digital port 206 is applied to each switch, and an output of the analog port 207 is applied to each switch via the MPEG2 encoder 214.

The receiver 200 further includes separate audio/video (A/V) processing paths for the network and for the receiver itself. The receiver A/V processing path includes a receiver A/V decoder and processor 215 and 216 to process, according to characteristic information of the receiver, at least one video program supplied to the receiver 200 via the signal input unit, while the network A/V processing path includes a network A/V decoder and processor 217 and 218 to process the at least one video program according to characteristic information of the terminal 300. Here, it should be appreciated that the second switch 212 receives the same inputs as the first switch 211. Accordingly, any input source can be processed and routed to the network or processed in the receiver only, or processed simultaneously via both A/V processing paths. For example, in response to a control signal received from the terminal 300, a video program from the first switch 211 can be stored in a video storage device via the HDD interface 210, and in turn routed through the network A/V processing path, or passed directly to the receiver A/V processing path, which can also process via the HDD interface a video program stored in a video storage device.

The network A/V processor 218 outputs a formatted video signal to a network interface 219, which receives characteristic information of the terminal 300 via the Internet server 100 and controls the network A/V processor accordingly. The received characteristic information is stored in a user information storage unit 220 according to each user (i.e., terminal device) in correspondence to user information (i.e., network access information), which is also stored in the user information storage unit. The stored information is used by an internal CPU of the network interface 219 to control the formatting of the video program output from the network A/V processor 218 under control of the system controller 201. The terminal characteristic information for processing the video program to be transmitted may be provided by the user information storage unit 220 or provided by the terminal 300. That is, terminal characteristic information may be included in the control signal received from the terminal 300, which is delivered to the system controller 201 via the network interface 219, to control operations of the elements of the receiver 200 via the receiver's controller. At the same time, a video program processed by or stored in the receiver 200 is delivered to the Internet server 100 via the network interface 219, which enables bi-directional data communication.

In more detail, the network A/V processor 218 includes a format converter 218a for converting the format of a selected video program to be suitable for the terminal 300, by converting a video program suitable for the screen format of the receiver 200 into a video format required by the terminal, according to the terminal's characteristic information. The system program stored in the system memory 202 is written to enable a video format of the selected video program to be converted for the characteristics of a variety of terminal devices. Therefore, when the user sends a request signal for the specific program, the system controller 201 receives the request signal via the network interface 219 and extracts the terminal characteristic information from the received signal or recognizes the characteristic (type) of the terminal 300 based on characteristic information previously stored in the user information storage unit 220. The system controller 201 then converts the video format of the selected video program to be suitable for the characteristic of the terminal 300 by controlling the network A/V processor 218 via the network interface 219, which may include a network controller or CPU (not shown) for outputting formatting control signals. The network A/V processor 218 may further include a scrambler 218b for scrambling the thus-formatted video program under control of the system controller 201. The scrambled video program is descrambled in the terminal 300.

A third switch (SW3) 221 is provided for selectively outputting one of the selected output of the second switch 212 and a controlled output of one of the video storage devices, e.g., HDDs 208 or 209 or a USB memory (not shown). Each of the first, second, and third switches 211, 212, and 221 may include a multiplexer. The third switch 221, however, serves as the main selector of the present invention, since the video program output via the third switch is the one that undergoes formatting for transmission the terminal 300. That is, the output of the third switch 221 is processed by a network signal processor according to the present invention, which comprises the network A/V decoder 217, the network A/V processor 218, the user information storage unit 220, and formatting control portions of the network interface 219 and system controller 201. Accordingly, the network signal processor of the present invention processes a selected video program to be transmitted to the terminal 300 by formatting, in response to a local control signal from the system controller 201, the selected video program according to characteristic information of the terminal and then transmits the formatted video program to the terminal via the network interface 219.

Then, in response to a transmission request signal of a specific program, the network interface 219 converts a formatted video program into an Internet protocol (IP) based packet signal and transmits the converted signal to the terminal 300 via the Internet server 100. Therefore, the network interface 219 may include a packetizer (not shown) for packetizing the formatted video program to be transmittable over the Internet (network). This converting process, which is separate from any format conversion, generally corresponds to a standard protocol.

The system controller 201 receives control signal information from the terminal 300 via the network interface 219. Thus, in response to a control signal requesting a specific video program, the system controller 201 determines the relative format types of the terminal 300 and the requested video program and outputs accordingly a formatting control signal to the network A/V processor 218 via network interface 219. The system controller 201 also determines a priority for the receiver's control. For this, the system controller 201 includes a local control signal processor 201a for executing receiver operations according to commands input from the user interface 203 (i.e., receiver commands), a remote control signal processor 201b for executing receiver operations according to the control signal received from the terminal 300 (i.e., terminal commands), and a priority determiner 201c for preferentially outputting to the receiver system a set of function control signals (system control) according to priority rules and conditions preset in the receiver 200 to overcome a mutual collision between the respective outputs of the local and remote control signal processors 201a and 201b.

Meanwhile, the network A/V processor 218 processes a video signal that may include an OSD image generated by an OSD/audio message generator 222 under control of the system controller 201 to be superposed with the video signal of, or incorporated into the audio processing of, the network A/V processor and then transmitted to the terminal 300 as announcement messages indicating, for example, that a requested video program is unavailable for transmission. The generated OSD and audio message data may also be provided to the receiver A/V processor 216. The announcement messages may be stored in the system memory 202 or the user information storage unit 220.

In addition, the OSD/audio message generator 222 enables the construction and viewing of lists of video program input sources and corresponding video programs currently available to the receiver 200. That is, in addition to a selected video program, the receiver 200 of the present invention may transmit to the terminal 300 a variety of additional data, including data for an OSD image display as text and/or graphics and data for an audio message output, which may be a simple tone or a prerecorded or computer-generated voice message. Under control of the system controller 201, such data is generated by the OSD/audio message generator 222, processed in the network A/V processor 218, and then transmitted to the terminal 300 via the network interface 219 and the Internet server 100, to be provided to the terminal user according to a received command signal and conditions at the receiver 200.

The OSD image may be displayed as one or more of Tables 1-3, either simultaneously or sequentially. Here, Table 1 represents an OSD image indicating a set of video program input sources, and Tables 2 and 3 each represent an OSD image indicating a set of sub-menu items corresponding to a selection with reference to Table 1. In other words, an OSD image according to Tables 2 and 3 may be respectively displayed in response to a terrestrial digital broadcast or internal recorder/reproducer selection per Table 1.

TABLE 1

video program input source
terrestrial digital broadcast
terrestrial analog broadcast
cable broadcast
external recorder/reproducer
internal recorder/reproducer

As demonstrated by Table 1, the OSD data can include a list of input signal sources currently used by or available to the receiver 200, which may at any given time be provided with access to one or more of plural cable and terrestrial digital and analog broadcasts and any number of internal and external players and storage media. The internal and external recorder/reproducers may be individually identified by type, e.g., a DVD player or PVR, and internal and external storage media may be similarly identified. The list is generated by the receiver 200 and is displayed by the terminal 300, to represent a current connection status of the receiver 200. That is, the list may be displayed on the terminal 300 in response to a video program request signal received from the terminal. Then, in the event that a user selects from the displayed OSD image one of the video program input sources, a set of sub-menu items may be displayed in correspondence to the selection.

For example, as demonstrated by Table 2, a selection of a terrestrial digital broadcast may result in display of a corresponding set of channels made available through a terrestrial digital broadcast input to the receiver 200, where the channels, i.e., sub-menu items, may be further identified using associative indicators, such as a local channel number and its network affiliation. At the same time, as demonstrated by Table 3, a selection of an internal recorder/reproducer may result in display of a corresponding set of programs recorded by a PVR of the receiver 200, where each program, i.e., sub-menu items, may be further identified by an index number and title.

TABLE 2
broadcast channels

| | |
|---|---|
| CH1 | BBC |
| CH2 | CBS |
| CH3 | NBC |
| CH4 | weather |
| . . . | . . . |
| CH6 | CNN |

TABLE 3
stored video program

| | |
|---|---|
| 1 | evening news |
| 2 | sports game |
| 3 | movie title |
| 4 | sitcom title |
| . . . | . . . |
| 6 | program title |

The terminal 300 receives the OSD data as above and processes the received data for display on a screen of the terminal. Once the user selects from a list such as Table 2 or 3, the selected video program is displayed on the screen. For example, if a user selects a specific item, the terminal 300 transmits a corresponding request signal and the necessary command signals to the receiver 200 via the Internet server 100, and the corresponding stream is sent back to the terminal. In the event that a list of stored programs such as that of Table 3 is displayed and a specific sub-menu item is selected, the receiver 200 may, under control of the system controller 201, extract program information and thumbnail information corresponding to a video program of the selected item, so that the extracted information may be formatted according to the characteristic of the terminal and the appropriate format-conversion information can be provided to the terminal 300 via the Internet server 100. In this case, preferably prior to transmission, the network A/V processor 218 downscales the generated OSD data and the thumbnail information to be suitable for the terminal 300.

On the other hand, the OSD image of Table 1 may include an option such as “current viewing,” whereby no further OSD images (tables) need be displayed. Thus, viewing at the terminal 300 simply follows that of the receiver 200, as “in-progress” viewing, regardless of the source of a video program or any intermediate local control of the receiver.

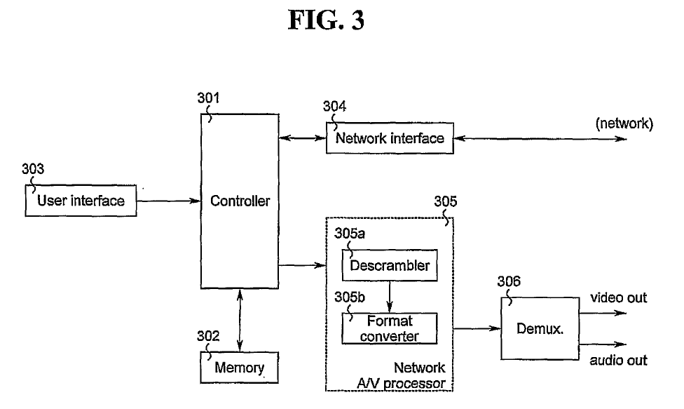

Referring to FIG. 3, the terminal 300 includes a controller 301 connected to a memory 302, a user interface 303, a network interface 304, and a network A/V processor 305. The controller 301 serves to control the overall system of the terminal 300, based on user commands received from the user interface 303, using the memory 302 for storing a system program and other necessary information. As in the case of the receiver 200, the network interface 304 delivers data to and from the receiver via the Internet server 100. In doing so, user authentication and control data is sent out to the receiver 200 and an incoming data stream is provided to the controller 301. The controller 301 also provides a control signal to the network A/V processor 305 to enable the received data stream to be formatted according to the characteristic (type) of the terminal 300. After appropriate formatting, the stream is then sorted into video data and audio data by a demultiplexer 306. That is, the output from the network signal processor 305 is provided to the demultiplexer 306, which provides separate video and audio outputs to be processed and output to a user, via a display screen and speaker arrangement (not shown), to provide the user with the appropriately formatted video signal, including OSD data and an audio message as necessary. For this, the terminal 300 is typically provided with a display, one or more speakers, and amplifying circuits (not shown).

The network A/V processor 305 may include a descrambler 305a and a format converter 305b, which are configured in an inverse manner with respect to corresponding elements of the network A/V processor 218 of the receiver 200. Accordingly, in response to a correct input of user information (e.g., a user ID and a password) via the user interface 303, the network A/V processor 305 descrambles the received data, i.e., the received video program that has been scrambled by the scrambler 218b of the receiver 200. Subsequently, the format converter 305b outputs an appropriately formatted video program according to the characteristic of the terminal 300. For example, assuming the video program has already been formatted by the receiver 200 to be suitable for the characteristic of the terminal 300, or if the terminal device is capable of processing the video program without such formatting, the received video program is simply passed through the format converter 305b, without format conversion being performed in the terminal. If, on the other hand, it is determined based on a comparison of the relative format types of the terminal 300 and the requested video program that formatting is necessary, the format converter 305b converts the format of the received video program to be suitable for the characteristic of the terminal 300.

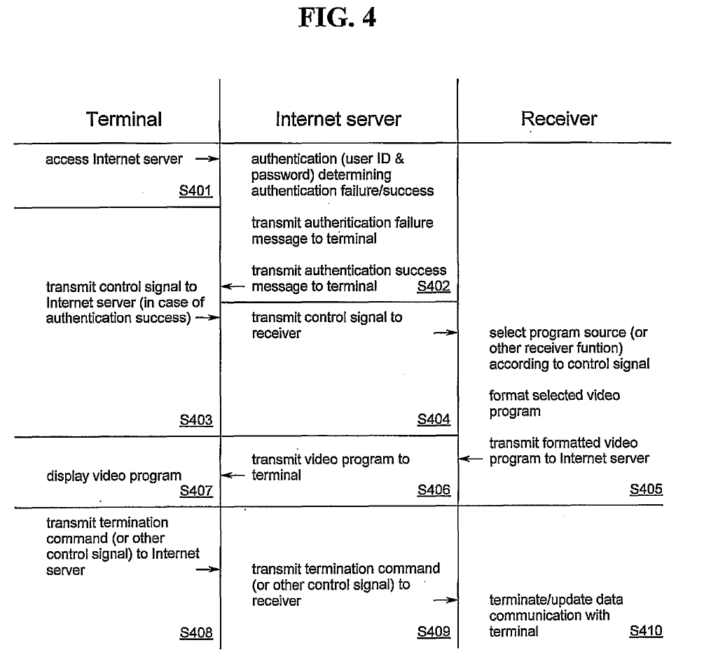

FIG. 4 illustrates a basic cycle of data communication performed between a terminal and receiver according to the present invention. First, for authentication purposes, a user provides user ID and password information to the Internet server 100 by entering the information into the control 301 via the user interface 303, whereby user authentication data is transmitted to the Internet server from the network interface 304. That is, the terminal 300 attempts to access the Internet server 100, which in turn executes an authentication process to determine authentication failure or success with respect to an instance of server accessing by the terminal (S401). To achieve this, the Internet server 100 stores in the database 102 a set of characteristic information for the terminal 300, i.e., a specific terminal; the terminal characteristic information may include one or more of the IP address of the terminal, a MAC address, and a password specified by a user. The Internet server 100 responds by transmitting an authentication success or failure message to the terminal 300 according to a result of the authentication process, whereby an authentication failure message is transmitted for each instance of authentication failure and an authentication success message is transmitted upon authentication success (S402). Upon receipt of an authentication success message, the terminal 300 transmits a control signal generated by the controller 301 according to a control command entered by the user, which is relayed to the receiver 200 via the Internet server 100 (S403, S404). Since the control signal may include a signal for controlling an operation of the receiver (i.e., a command signal) as well as a signal for requesting a specific video program, which may be transmitted simultaneously or sequentially, the receiver 200 confirms reception of the control signal and determines whether a corresponding function is executable.

Subsequently, based on the request signal of the received control signal, the system controller 201 of the receiver 200 recognizes the terminal's characteristic and identifies the requested video program. If the characteristic information for the terminal is not received from the terminal 300, or even if the terminal characteristic information is included in the request signal, the receiver 200 can use the terminal characteristic information stored in the user information storage unit 220. Meanwhile, according to the received control signal, the receiver 200 executes a corresponding receiver function, such as selecting a program source or searching an internal or external video storage device, e.g., the HDD 208 or HDD 209, to select the specific video program source and output the requested video program. For example, as stated above, in addition to a request signal, the control signal may include a command signal such as a video program source designation command, a channel selection or volume adjustment command, a communication termination command, or a PVR operation command, e.g., a control signal for executing a PVR play start/end function. In this case, a list of video program sources or available channels and stored programs, such as in Tables 1-3, may be displayed on a screen of the terminal 300, enabling the user to select a desired video program source and a specific video program by referencing the displayed lists. Here, the list information may be prestored in the memory 302 or transmitted as current (real-time) information from the receiver 200 to the terminal 300 during an intermediate step.

Subsequently, the system controller 201 of the receiver 200 modifies (formats) the requested video program to be suitable for the characteristic of the terminal 300, i.e., according to the type of the terminal device. The receiver 200 converts the formatted (reformatted) video program into an IP-based packet signal for transmission via the Internet server 100 to the terminal 300, which displays the selected video program (S405, 5406, S407). Thereafter, if the user enters a control signal including a command signal for ordering a termination, the terminal 300 transmits the control signal to the Internet server 100, which relays the termination command to the receiver 200, whereby the receiver executes the corresponding function (S408, 5409, S410). Here, it should be appreciated that the video program may be viewed in its entirety, or the user may decide to view another program by updating the above data communication process.

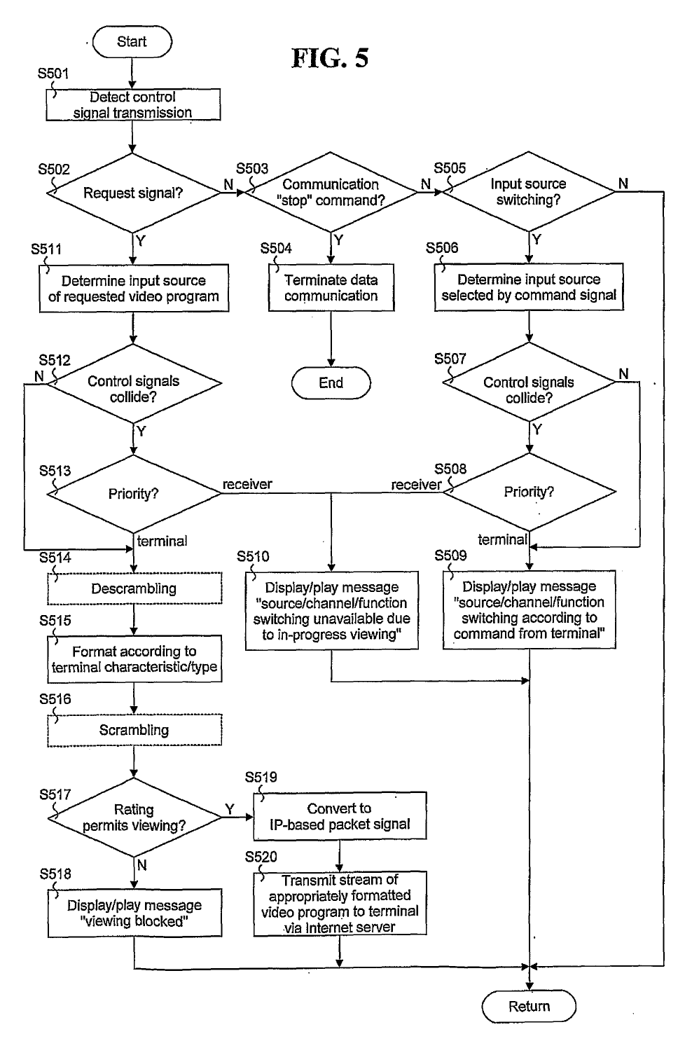

FIG. 5 illustrates a process for performing data communication between a terminal and a receiver. The process is largely carried out by the system controller 201 of the receiver 200, which may include an internal or external recorder/reproducer or video storage device and at least one video program input source.

First, the system controller 201 detects reception of a control signal for requesting a specific video program, though control signal transmission may be detected by the Internet server 100 (S501). Such a control signal, initiated by a user, is transmitted from the terminal 300 and travels via the Internet server 100 to arrive at the receiver 200, specifically at the network interface 219. In other words, the system controller 201 first determines whether a received control signal is a video program transmission request signal from the terminal 300 (S502). This initially transmitted control signal may include information for identifying a specific video program, or such information may be subsequently transmitted, i.e., after an initial request signal. According to a user selection, the received control signal may or may not include terminal characteristic information, and the system controller 201 determines whether to update the storage in the user information storage unit 220 based on such received terminal characteristic information. Meanwhile, it is determined whether the received control signal is a communication “stop” command, thereby enabling data communication (or current routine) to be terminated at any time (S503, S504). It is further determined whether the received control signal includes a command signal for changing the current input source selection, which may result in display of an OSD image such as in Table 1 (S505). Such a control signal may be a request signal for switching a currently requested video program to a new video program.

In the event that the control signal commands the receiver 200 to switch from its current input source selection, the system controller 201 determines an available selection of input sources and, upon receiving an input source selection from the user, notifies the user of the selection results, namely, whether the selection will be effected by the receiver, and the routine may pause in anticipation of an appropriate user response, for example, during OSD image navigation. That is, the system controller 201 recognizes the input source selected by a received command signal, for example, by sequentially checking whether the command signal corresponds to any of the available input sources, which may include a number of respectively arranged video input ports, digital and analog tuners, internal and external players, and internal and external storage devices (S506). It is then determined whether the receiver and terminal control signals collide with each other, and if so, whether the terminal control signal has priority over the receiver control signal (S507, S508). For example, even if the receiver 200 has priority, it may be previously determined that the requested video program or recognized source directly corresponds to the receiver's current viewing condition (i.e., in-progress viewing), such that the transmission of the requested video program may be permitted until such time as the control signals collide or priority is transferred to the terminal 300. Based on this determination, the system controller 201 may transmit an announcement message, such as a help screen or voice recording, indicating whether there may be a reason to prohibit execution of the corresponding function of the command signal, which may include commands beyond a simple source selection. Examples of such messages, which may be presented in text or audio form, include “source/channel/function switching according to command from terminal” for cases where a current input source (or channel selection, volume adjustment, etc.) is set according to the receiver 200, but the control signal of the terminal 300 has priority; and “source/channel/function switching unavailable due to in-progress viewing” for cases where a current input source (or channel selection, volume adjustment, etc.) is set according to the receiver, with the receiver's control signal retaining priority (S509, S510). It should be appreciated that there may be various reasons for precluding an instance of data stream transmission, for example, where the receiver 200 has only one tuner, which may be currently providing a video program source for another user (i.e., a second terminal) on another channel.

It may be appreciated that an initial determination of a correct input source selection per the step 5505 is, in accordance with a desired video program selection, preferably performed prior to the transmission of a video program transmission request signal. For this reason, display of the OSD data of Table 1 typically precedes display of the OSD data of, for example, Table 2 or 3. Upon receipt by the receiver 200 of a video program transmission request signal, the system controller 201 may assume that current input source corresponds to the specific video program, as in the case of an appropriate user response during OSD image navigation, or may determine which available input source corresponds to the specific video program, for example, by a sequential checking (e.g., a search) as in the step S505. In any event, in determining whether a current or selected input source corresponds to the specific video program, it is determined whether the receiver and terminal control signals collide with each other, and if so, whether the terminal control signal has priority over the receiver control signal (S511, S512, S513). Based on this determination, the system controller 201 performs format conversion according to the received or stored terminal characteristic information, which may (i.e., if necessary) occur after descrambling a video program that may have been scrambled for secure transmission or storage during a previous processing stage (S514, S515). Thereafter, according to a preset condition or user selection, the requested video program may be scrambled, using the scrambler 218b, prior to its transmission over the Internet (S516).

Meanwhile, in accordance with a user selection, a video program may be imparted with a viewer rating, and a terminal may be provided with a blocked viewing setting. Therefore, the system controller 201 checks whether the selected and requested video program has a viewer rating permitting its viewing by the terminal 300, say, for all audiences, and if not, the system controller may transmit (display/play) an announcement message indicating that transmission of the video program is prohibited (S517, S518). Examples of such a message, which may be presented in text or audio form, include “viewing blocked” If the rating permits viewing, the system controller 201 converts the video program, which may be scrambled, to an IP-based packet signal, to thereby stream the appropriately formatted video program to the terminal 300 via the Internet server 100 (S519, S520). Streaming may continue until such time as the video program may be completed or otherwise interrupted, for example, by a communication stop command.

Accordingly, the format of a video program is converted to be suitable for the characteristic (type) of the terminal 300 according to a control signal received by or stored in the receiver 200. That is, the characteristic information for the terminal 300 may or may not be included in the control signal, since the system controller 201 may access the user information storage unit 220 to retrieve terminal characteristic information indicating the appropriate format conversion for the terminal. Then, the system controller 201 processes a specific video program according to the characteristic of the terminal 300, to enable remote viewing of a variety of home-viewable content, by appropriately formatting the specific video program for any one of a cellular telephone, a notebook computer, a PDA, or other remote or mobile terminal. Finally, the video program, processed (formatted) according to the characteristic of the terminal 300, is transmitted to the terminal via the Internet server 100. On the other hand, the necessary formatting may be performed by the terminal itself, for example, if the stored characteristic information is incorrect or obsolete.

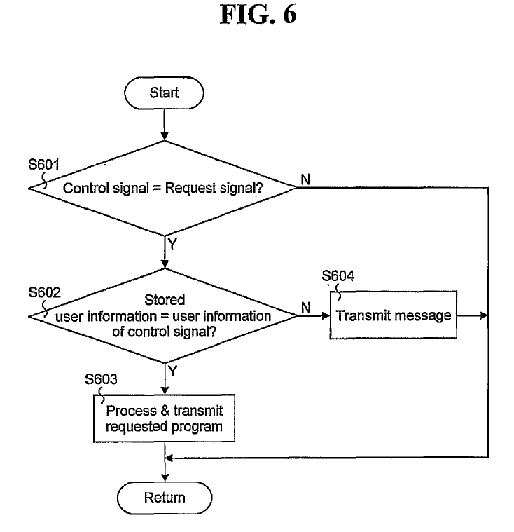

FIG. 6 illustrates a process for performing data communication by confirming the validity of user information according to the present invention. Here, the user information may include at least one of a user ID and a password previously agreed between the terminal 300 and the receiver 200. Alternatively, the user information may correspond directly to terminal identifying information, i.e., information identifying a terminal device rather than its user.

In any event, if a control signal received by the receiver 200 includes a request signal for requesting transmission of a specific video program, the system controller 201 determines whether valid user information exists in correspondence to the request signal (S601, S602). To do so, the received user information is compared to user information stored in the user information storage unit 220 to determine whether a match condition exists for the user information. If the corresponding user information is thus confirmed to be valid, the receiver 200 processes (to include formatting as necessary) and transmits the corresponding video program to the terminal 300 (S603). On the other hand, if the comparison fails to detect a proper match condition, the system controller 201 of the receiver 200 does not execute the above video program formatting and transmission processes and instead transmits an appropriate announcement message notifying the user of the condition (S604). It should be appreciated that the user information may be included in the transmitted control signal, i.e., together with the request signal, or separately transmitted before or after transmission of a specific request signal.

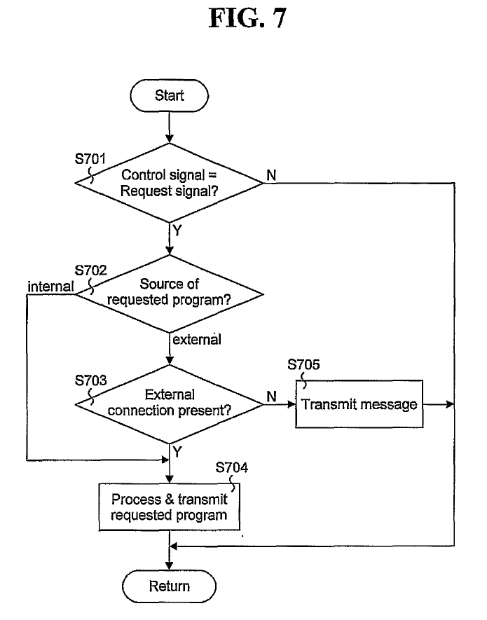

FIG. 7 illustrates a process for performing data communication by determining the availability of a video program via an external source according to the present invention, which considers the case where the status of external connections to the receiver 200 renders transmission of a specific video program impossible. Upon receipt of a video program request signal from the terminal 300, the system controller 201 determines whether transmission of the requested video program has a source (e.g., an external recorder/reproducer or a cable input port) requiring an internal or external connection with respect to the receiver 200 (S701, S702). It is then determined, for example, whether there is a corresponding external connection present with respect to the source; if so, the receiver 200 subsequently processes and transmits the video program (S703, S704). It should be appreciated, however, that there may be no corresponding external connection present with respect to the source, or that there may be another cause, such as a technical failure or service outage, which would render the receiver 200 unable to acquire an external signal. Thus, when the receiver 200 is incapable of transmitting the requested video program, the system controller 201 prepares and transmits a corresponding announcement message (S705).

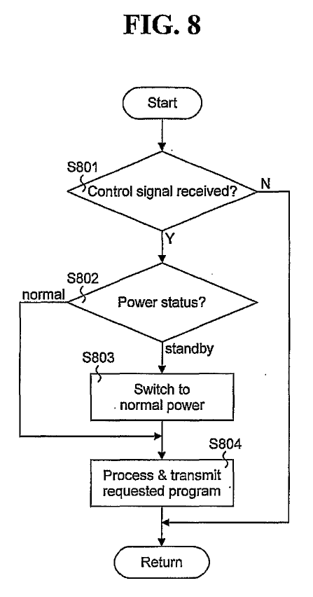

FIG. 8 illustrates a process for performing data communication based on a power status of the receiver according to the present invention, which considers the case where the receiver 200 may be in a standby power mode, such that power is supplied to basic system elements only, specifically including a system controller enabling such functions as time keeping and main power control. For instance, when its power plug is fitted into a power socket, a television receiver, as a typical home appliance, may maintain a standby power status rather than operating in a normal power mode. Accordingly, upon receipt of a control signal from the terminal 300, the system controller 201 determines the current status of the power mode of the receiver 200 (S801, S802). If the receiver 200 is in standby power mode, the main power of the receiver 200 is switched on, to resume a normal power mode, and the receiver subsequently processes and transmits the video program (S803, S804). Here, it should be noted that, even with the receiver 200 in a standby power mode, the system controller 201 is capable of routing power to various elements of the receiver. Should the receiver's primary power source be removed altogether, as in the case of a power plug being detached from the power socket, such that the receiver's routine is interrupted (terminated), the controller 301 of the terminal 300 may display (output) a message indicating data communication with the receiver 200 is unavailable.

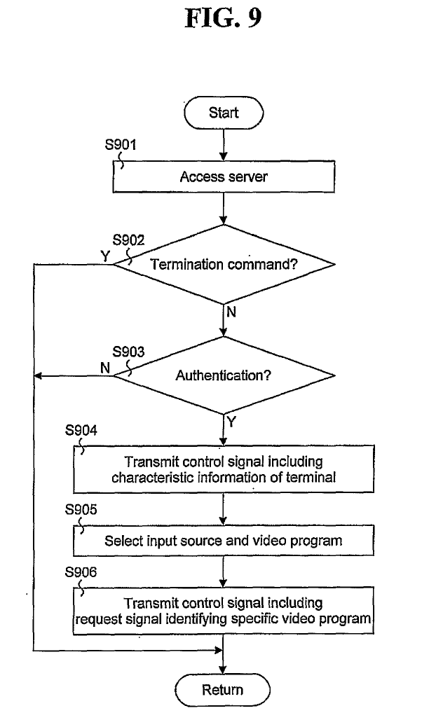

FIG. 9 illustrates a process for performing data communication with a receiver in a terminal according to the present invention, where the receiver may include an internal or external recorder/reproducer or video data storage device and at least one video program input source. The process is largely carried out by the controller 301 of the terminal 300.

First, a user enters a command for generating a control signal, namely, a request signal for remotely playing a specific video program from a receiver which may be provided with at least one input source (e.g., a digital or analog tuner or an internal or external player or storage device), to the controller 301 of the terminal 300 via the user interface 303. In doing so, the controller 301 attempts to access the Internet server 100, which executes an authentication process (S901). While connected to the Internet server 100, a termination command may be entered by the user, whereby the controller 301 performs an Internet disconnection routine (S902). On the other hand, upon successful authentication, the terminal 300 transmits to the receiver 200 a control signal including its characteristic information such as resolution and screen size (S903, S904). This characteristic information may include information identifying the terminal 300 as a specific device or device type. In the event that no terminal characteristic information is received from the terminal 300, the system controller 201 of the receiver 200 may process the selected video program using terminal characteristic information previously stored in a memory within the receiver, for example, in the user information storage unit 220, by referencing the user information corresponding to the request signal. Upon receipt or retrieval of the terminal's characteristic information, the receiver 200 generates and transmits OSD data such as that of Table 1, which may be performed without a specific request signal from the terminal 300. For example, although OSD data generation is not requested by the terminal 300, the system controller 201 of the receiver 200 may, in response to a control signal received from the terminal, control the OSD/audio message generator 222 to generate OSD data for listing input sources currently available for the receiver together with other information. As in the case of formatting a video program to be transmitted, the receiver 200 may prior to transmission process an entire OSD image into a format suitable for the specification of the terminal 300.

The generated OSD image may thus be displayed according Table 4.

TABLE 4

| source | status | content |
|---|---|---|
| digital | in progress | CH10 |
| analog | stop | — |
| A/V₁ | play/stop | title |
| A/V₂ | play/stop | title |
| HDD | play/stop | title |

By referencing a set of input source information as above, which is displayed on a screen of the terminal 300, the user selects a specific input source and video program (S905). Based on the selection, the controller 301 transmits to the receiver 200 a corresponding control signal requesting the selected video program (S906). Upon receiving the request signal, the receiver 200 recognizes the requested video program, and the system controller 201 searches for the corresponding video program by scanning the video programs stored in a video storage unit and other available video input sources.

Meanwhile, the system controller 201 of the receiver 200 connected to the Internet server 100 continuously checks for reception of a signal for remotely controlling its operation or that of a peripheral device and may perform a corresponding function based on a priority determination. For instance, in response to a user selection (input command) to the controller 301 of the terminal 300, a request signal for selecting a specific video program is transmitted to the receiver 200, which recognizes the video program and executes one or more corresponding functions accordingly. Assuming valid user information, the receiver 200 may further perform an operation of searching for the corresponding video program. In the event that the specific video program selection necessitates a reconfiguration of its video input connections, tuning, etc., the receiver 200 may even reset its video input connections as necessary. As mentioned in the foregoing description, the video program, which is scrambled in the receiver 200 prior to its transmission to ensure use by an intended user, is descrambled via a process for confirming user information in the terminal 300 and is then depacketized. The depacketized video program is displayed on a screen of the terminal 300.

By adopting the present invention, a remote user, i.e., a user of a mobile (portable) terminal connected to a network, is able to view video programs of a video receiver, including cable or satellite broadcasts provided to the receiver and external video players storage devices, in real time, regardless of the location of the receiver, which is typically located in the home. Accordingly, any home-viewable broadcast or video program (video content) can be viewed on-line anywhere without restrictions to the user's location. Moreover, such video content can be viewed without additional subscriber fees.

### INDUSTRIAL APPLICABILITY

It will be apparent to those skilled in the art that various modifications can be made in the present invention without departing from the spirit or scope of the invention. Thus, it is intended that the present invention covers such modifications provided they come within the scope of the appended claims and their equivalents.

1. A method of performing data communication with a terminal at a receiver, the method comprising:
receiving a control signal from a terminal via a network, the control signal including a request signal identifying a specific video program;
processing, in response to the received control signal, the specific video program according to characteristic information of the terminal; and
transmitting the processed video program to the terminal via the network.

2. A method according to claim 1, said specific video program processing comprising:
formatting the specific video program in correspondence to the characteristic information of the terminal.

3. A method according to claim 2, said specific video program processing further comprising:
scrambling the formatted video program to inhibit viewing of the specific video program without user authorization.

4. A method according to claim 1, wherein the control signal includes a command signal for controlling an operation of the receiver.

5. A method according to claim 1, wherein the video program includes a video program of a terrestrial television broadcast, a video program of a cable broadcast, a video program received from an external video source connected to the receiver, and a video program stored in the receiver.

6. A method according to claim 1, wherein the terminal includes one of a notebook computer, a PDA, and a cellular telephone.

7. A method of performing a data communication with a terminal at a receiver having an internal video recorder/reproducer and at least one input port connected to an external video source, the method comprising:
receiving a control signal from the terminal via a network, the control signal including a request signal identifying a specific video program;
selecting a video program corresponding to the specific video program identified by the control signal;
processing, in response to the received control signal, the selected video program according to characteristic information of the terminal; and
transmitting the processed video program to the terminal via the network.

8. A method according to claim 7, wherein the selected video program is output from any one of the internal video recorder/reproducer and the at least one input port.

9. A method according to claim 7, further comprising:
recognizing one of a plurality of video programs as the specific video program, said recognizing being performed according to the received control signal, wherein said processing is performed with respect to the recognized video program.

10. A method according to claim 9, wherein the plurality of video programs includes at least one video program stored in the internal video recorder/reproducer.

11. A method according to claim 9, wherein the plurality of video programs includes at least one video program from the external video source.

12. A method according to claim 9, wherein the plurality of video programs includes at least one video program received by the receiver.

13. A method according to claim 7, wherein the control signal includes a command signal for selecting one of the internal video recorder/reproducer and the at least one input port.

14. A method according to claim 13, wherein the specific video program is selected according to the command signal of the control signal.

15. A method according to claim 14, wherein the command signal selection is determined based on the specific video program identified by the control signal.

16. A method of performing a data communication with a terminal at a receiver having an internal video recorder/reproducer and at least one input port connected to an external video source, the method comprising:
performing, in response to a user request, an authorization process to access a server of a network from the terminal;
transmitting a control signal to the receiver via the network upon a successful completion of the authorization process, the control signal including a request signal identifying a specific video program;
recognizing one of a plurality of video programs as the specific video program, said recognizing being performed according to the received control signal;
selecting a video program corresponding to the recognized video program;
processing the selected video program according to characteristic information of the terminal;
transmitting the processed video program from the receiver to the terminal via the network; and
receiving the transmitted video program at the terminal.

17. A method according to claim 16, wherein the video program includes a video program of a terrestrial television broadcast, a video program of a cable broadcast, a video program received from an external video source connected to the receiver, and a video program from the internal recorder/reproducer.

18. A method according to claim 16, wherein the control signal includes a command signal for selecting a new video program as the specific video program.

19. A method according to claim 18, wherein the command signal selects the new video program from one of the internal video recorder/reproducer and the at least one input port.

20. A method according to claim 18, wherein the command signal is a channel tuning control signal for the receiver.

21. A receiver, comprising:
a signal input unit for receiving at least one video program;
a network interface for performing data communication with respect to a terminal;
a controller for controlling an operation of the receiver according to a remote control signal received from the terminal via said network interface, the remote control signal including a request signal identifying a specific video program, and for generating a local control signal for processing the specific video program; and
a network signal processor for formatting the specific video program according to characteristic information of the terminal and for transmitting the formatted video program to the terminal via said network interface.

22. The receiver according to claim 21, wherein the characteristic information of the terminal is pre-stored in an internal memory of the receiver.

23. The receiver according to claim 21, wherein the characteristic information of the terminal is included in the remote control signal received from the terminal.

24. A receiver, comprising:
a signal input unit for receiving at least one video program;
a video storage device for storing the at least one video program according to a user selection;
a network interface for performing data communication with respect to a terminal;
a controller for controlling an operation of the receiver according to a remote control signal received from the terminal via said network interface, the remote control signal including a request signal identifying a specific video program, and for generating a local control signal for processing the specific video program;
a selector for selecting, according to the local control signal, a video program corresponding to the specific video program; and
a network signal processor for formatting, in response to the local control signal, the selected video program according to characteristic information of the terminal and for transmitting the formatted video program to the terminal via said network interface.

25. A receiver according to claim 24, further comprising:
a receiver signal processor for processing the at least one video program according to characteristic information of the receiver.

26. A receiver according to claim 25, wherein the selected video program is output from either one of said receiver signal processor and said video storage device.

27. A receiver according to claim 24, said network signal processor comprising:
a video program decoder for decoding the selected video program;
a format converter for formatting the selected video program according to the characteristic information of the terminal; and
a scrambler for scrambling the formatted video program.
